(19) United States
(12) Patent Application Publication
(10) Pub. No.: US 2012/0148006 A1
(43) Pub. Date: Jun. 14, 2012

(54) NUCLEAR REACTOR CONTROL ROD DRIVE MECHANISM

(75) Inventor: Richard Morris, East Granby, CT (US)

(73) Assignee: WESTINGHOUSE ELECTRIC COMPANY LLC, CRANBERRY TOWNSHIP, PA (US)

(21) Appl. No.: 13/280,478

(22) Filed: Oct. 25, 2011

Related U.S. Application Data
(60) Provisional application No. 61/422,685, filed on Dec. 14, 2010.

(51) Int. Cl. G21C 7/12

(52) U.S. Cl. 376/228

(57) ABSTRACT

A magnetic jack control rod drive mechanism for a nuclear reactor in which the stationary gripper coil, moveable gripper coil and lift coil are constructed with ceramic or quartz insulation.

### CROSS REFERENCE TO RELATED APPLICATIONS

This application claims priority to Provisional Application Ser. No. 61/422,685, filed Dec. 14, 2010, entitled CONTROL ROD DRIVE MECHANISM ALL WEATHER DRIVE ROD POSITIONING DEVICE.

### BACKGROUND

1. Field

This invention relates in general to nuclear reactor control systems and, in particular, to systems for controlling the movement of nuclear control rods into and out of the core of a nuclear reactor.

2. Description of Related Art

In a nuclear reactor for power generation, such as a pressurized water reactor, heat is generated by fission of a nuclear fuel such as enriched uranium, and transferred into a coolant flowing through a reactor core. The core contains elongated nuclear fuel rods mounted in proximity with one another in a fuel assembly structure through and over which the coolant flows. The fuel rods are spaced from one another in co-extensive, parallel arrays. Some of the neutrons and other atomic particles released during nuclear decay of the fuel atoms in a given fuel rod pass through the spaces between fuel rods and impinge on the fissile material in adjacent fuel rods, contributing to the nuclear reaction and to the heat generated by the core.

Moveable control rods are dispersed throughout the nuclear core to enable control of the overall rate of the fission reaction, by absorbing a portion of a neutron passing between fuel rods, which otherwise would contribute to the fission reaction. The control rods generally comprise elongated rods of neutron absorbing material and fit into longitudinal openings or guide thimbles in the fuel assemblies running parallel and between the fuel rods. Inserting a control rod further into the core causes more neutrons to be absorbed without contributing to fission in an adjacent fuel rod; and retracting the control rod reduces the extent of neutron absorption and increases the rate of a nuclear reaction and the power output of the core.

The control rods are supported in cluster assemblies that are moveable to advance or retract a group of control rods relative to the core. For this purpose, control rod drive mechanism are provided, typically as part of an upper internals arrangement located within the nuclear reactor vessel above the nuclear core. The reactor vessel is typically pressurized to a high internal pressure, and the control rod drive mechanisms are housed in pressure housings that are tubular extensions of the reactor pressure vessel. FIG. 1 is a schematic view of a prior art nuclear containment 10 housing a nuclear reactor pressure vessel 12 having a nuclear core 14 supported within the lower half of the pressure vessel 12. A control rod assembly 16, i.e., one of the cluster assemblies, is shown within the core 14 and supports a cluster of control rods 18 that are moved into and out of the fuel assemblies (not shown) by a drive rod 20. The drive rod 20 is moveably supported by a drive rod housing 24 that extends upwardly and through a removable reactor closure head 22. Control rod drive mechanisms (CRDM) are positioned above the reactor head around the control rod drive housing 24 and move the drive rods in a vertical direction to either insert or withdraw the control rods 18 from the fuel assemblies within the core 14. Rod position indicator coils 26 or other indicator mechanisms are positioned around the housing 24 to track the position of the drive rod 20, and thus the control rods 18 relative to the core 14. The output of the rod position indicator coils 26 is fed through a processor rod position indicator (RPI) electronics cabinet 28 within the containment 10. The output of the rod position indicator electronics cabinet 28 is then fed outside the containment to a larger cabinet 30 and an RPI processing unit 32. The larger cabinet 30 interfaces with the control system 34 which provides manual instructors from a user interface 36 as well as automatic instructions which generate from the intelligence from plant sensors not shown. The larger cabinet 30 receives the manual demand signals from an operator through a user interface 36 and reactor control system 34 or automatic demand signals from the reactor control system 34 and provides the command signals needed to operate the control rods 18 according to a predetermined schedule. The power cabinet 38 provides a programmed current to operate the CRDM, all in a well-known manner.

One type of mechanism for positioning a control rod assembly 16 is a magnetic jack-type mechanism, operable to move the control rod drive rod by an incremental distance into or out of the core in discrete steps. In one embodiment, the control rod drive mechanism has three electromagnetic coils and armatures or plungers that are operated in a coordinated manner to raise and lower the drive rod shaft 20 and a control rod cluster assembly 16 coupled to the shaft 20. The three coils (CRDM) are mounted around and outside the pressure housing 24. Two of the three coils operate grippers that when powered by the coils engage the drive rod shaft, with one of the grippers being axially stationary and the other axially moveable.

The drive rod shaft has axially spaced circumferential grooves that are clasped by latches on the grippers, spaced circumferentially around the drive rod shaft. The third coil actuates a lift plunger coupled between the moveable gripper and a fixed point. If power to the control rod mechanism is lost, the two grippers both release and the control rods drop by gravity into their maximum nuclear flux damping position. So long as control rod power remains activated, at least one of the stationary grippers and the moveable gripper holds the drive rod shaft at all times.

The three coils are operated in a timed and coordinated manner alternately to hold and to move the drive shaft. The sequence of gripping actions and movement is different depending on whether the step-wise movement is a retraction or an advance. The stationary gripper and the moveable gripper operate substantially, alternately, although during the sequence of movements both grippers engage the drive shaft during a change from holding stationary to movement for an advance or retraction. The stationary gripper can hold the drive shaft while the moveable gripper is moved to a new position of engagement, for lowering (advancing) the drive shaft and the control rods. The moveable grippers engage the drive shaft when moving it up or down as controlled by the lift plunger. After the moveable gripper engages the drive shaft, the stationary gripper is released and then the plunger is activated or de-activated to effect movement in one direction or the other. Typically, each jacking or stepping movement moves the drive rod shaft ⅝ inch (1.6 cm), and some 228 steps are taken at about 0.8 seconds per step, to move a control rod cluster over its full span of positions between the bottom and the top of the fuel assembly.

A number of particular coil mechanisms and gripper mechanisms are possible. Examples of coil jacking mechanisms with a stationary gripper, a moveable gripper and a lifting coil as described heretofore are disclosed, for example, in U.S. Pat. Nos. 5,307,384, 5,066,451 and 5,009,834. In addition, four and five coil linear drive mechanisms have been employed that operate in a similar manner such as that described in U.S. Pat. No. 3,959,071.

Whatever mechanical arrangement is employed for the grippers and lifting coil/armature arrangement, the existing control rod drive mechanisms used in the pressurized water reactor fleet require generous amounts of forced cooling air provided by large fans installed on or in close proximity of the reactor vessel closure head. This need for cooling is driven by the thermally limited design of the CRDM coil assemblies which provide the electrically driven magnetic field which operate the grippers to position the control drive rods. Typically, two to three expensive large volume cooling fans are required to provide the required forced cooling air, that need maintenance and replacement periodically. Additionally, this cooling structure adds to the cost of removing the reactor head during outages. Elimination of the need for this cooling will not only reduce equipment and maintenance costs, but may well increase the thermal efficiency for the existing closure head area insulation.

Accordingly, it is an object of the embodiments described hereafter to provide a new coil arrangement that will eliminate or reduce the need for such cooling.

### SUMMARY

These and other objects are achieved by the following exemplary embodiments of the inventions claimed hereafter which provide for a nuclear reactor having a plurality of control rods that are driven into and out of a nuclear core by a magnetic jack mechanism having the improvements provided for herein. The nuclear reactor includes a drive rod connected to at least some of the control rods and moveably supported outside of the nuclear core along an axial drive path that aligns the control rods with which it is connected with guide thimbles in a fuel assembly within the nuclear core. A housing extends from the nuclear reactor in the axial direction and encloses at least a portion of the drive path. A plurality of electric coils are positioned around the housing for energizing the magnetic jack mechanism with the surface of the coils covered by a high temperature insulation, such as a ceramic or quartz material, capable of functioning as an effective electrical insulation in a reactor temperature environment without external cooling. Preferably, the high temperature insulation is coated on the coils or drawn over the coil wires as a flexible sleeve. In one embodiment, the high temperature insulation is a liquid coating. In still another embodiment, the insulation is a powdered coating.

### BRIEF DESCRIPTION OF THE DRAWINGS

A further understanding of the invention can be gained from the following description of the preferred embodiments when read in conjunction with the accompanying drawings in which:

FIG. 1 is a schematic view of a nuclear containment showing an outline of a nuclear reactor vessel supporting a control rod drive system for inserting and withdrawing a control rod assembly into and out of the core of the reactor vessel;

FIG. 2 is an enlarged schematic view of the control rod drive shaft drive system shown in FIG. 1 with a portion cut away to show the internal elements of the drive system;

FIG. 3 is a sectional view of one of the coils of the magnetic jack control rod drive system shown in FIG. 1; and

FIG. 4 is an enlarged sectional view of a portion of one winding of the coil shown in FIG. 3.

### DESCRIPTION OF THE PREFERRED EMBODIMENT

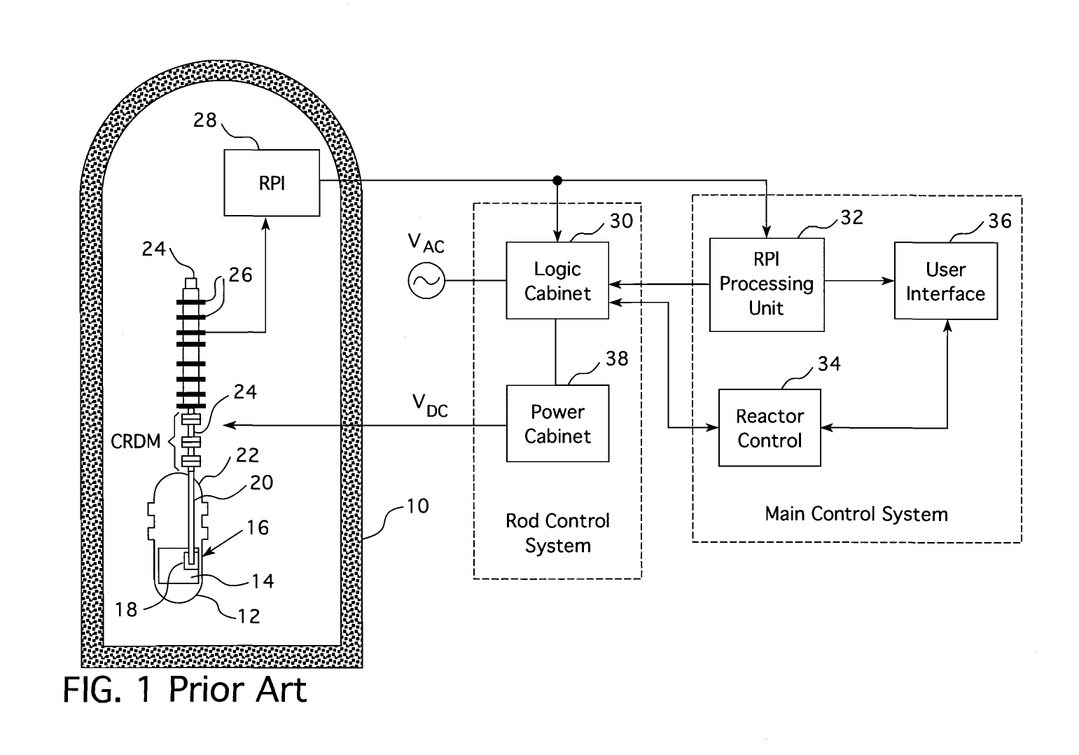

As stated in regard to FIG. 1, the control rods are attached in clusters 16, referred to as control rod assemblies, with each cluster being commonly driven by a drive rod 20 disposed in a vertical support housing 24 above the reactor core 14 containing the fuel rod assemblies into which the control rods 18 are advanced or from which the control rods are retracted for variable damping of nuclear flux within the reactor core. The moving parts of the control rod drive mechanism are within the pressure envelope of the reactor and the electromagnetic coils (CRDM) for driving the moveable parts are disposed around and about each of the housings 24 that extends above the reactor.

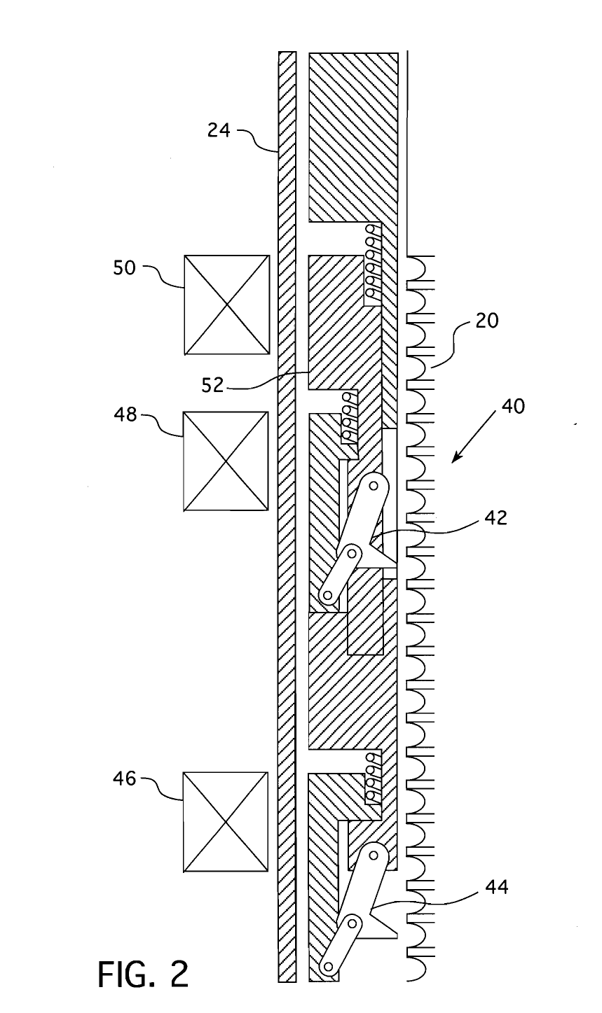

FIG. 2 shows a drive rod drive mechanism 40 with the extended portion of the housing 24 partly cut away to show the grippers 42 and 44 that are operable in sequences to engage, lift and/or lower the drive rod 20 when the associated coils 46, 48 and 50 of the drive mechanism 40 are energized in a prescribed sequence. This arrangement is substantially as disclosed in U.S. Pat. No. 5,009,834.

The digital rod control system is a system that functions in conjunction with the nuclear plant instrumentation and control systems 34, as shown in FIG. 1, to insert or withdraw the control rods from the reactor core. A nuclear plant commonly contains a number of control rod assemblies that are arranged in groups; typically, four control rod assemblies per group. Groups of control rod assemblies are usually inserted/withdrawn together to regulate reactor temperature and power. The instrumentation and control system 34 monitors reactor temperature and power and provides signals to the digital rod control system to demand rod motion as appropriate. In response to these demand signals, the digital rod control system inserts/withdraws the control rods. Control rod motion is accomplished by cycling the electric power on/off to the various coils 46, 48 and 50 in the control rod drive mechanism 40 (shown in FIG. 2).

The control rod drive mechanism employed in many of the commercial pressurized water reactors is a magnetic jack mechanism that can move the drive rod 20 of a control rod assembly 16 in fixed increments each time power to the coils is cycled. A spider of control rods 18 is attached to the bottom of the control rod drive rod 20 (sometimes referred to as the drive shaft) so that all the control rods within an assembly move together. The control rod drive mechanism 40 shown in FIG. 2 contains three coils; a stationary gripper coil 46, a moveable gripper coil 48 and a lift coil 50. As mentioned in the previous paragraph, by cycling electric power to these coils on and off in different sequences, the control rod mechanism 40 can cause the control rod drive shaft 20 and the control rods 16 to insert into or withdraw from the nuclear core. More particularly, for lifting (retracting) the control rods, the following steps are accomplished in sequence, beginning with the stationary gripper 44 engaged in a drive rod groove and the moveable gripper 42 and plunger both being de-activated. The sequence for lifting the drive rod 20 is:
1) the moveable gripper coil 48 is energized which causes the moveable gripper 42 to engage an adjacent drive rod groove;
2) the stationary gripper coil 46 is de-energized and disengages the stationary gripper 44 from the drive rod 20;
3) the lift coil 50 is energized and magnetically lifts the moveable gripper 44 and the drive rod 20 an elevation equal to the span of the lift plunger 52;
4) the stationary gripper coil 46 is then energized which moves the stationary gripper 44 into contact with the adjacent drive rod groove to hold the drive rod at the new elevation, i.e., both grippers are engaged;
5) the moveable gripper coil 48 is then de-energized and disengages the moveable gripper 42 from the drive rod groove; and
6) the lift coil 50 is de-energized, which drops the moveable gripper 42 back to its start position, only one step lower on the lifted drive rod 20.

Similarly, for lowering (advancing) the control rods, the following steps are accomplished in sequence, again beginning with only the stationary gripper coil 46 energized. The lowering sequence is:
1) the lift coil 50 is energized, moving the moveable gripper 42 one step up along the drive rod 20;
2) the moveable gripper coil 48 is energized and the moveable gripper 42 grips the drive rod 20;
3) the stationary coil 46 is de-energized releasing the stationary gripper 44 from the drive rod 20;
4) the lift coil 50 is de-energized, dropping the moveable gripper 42 and the drive rod one step;
5) the stationary coil 46 is energized and the stationary gripper 44 engages the drive rod 20, at a position one step higher than its previous position; and
6) the moveable coil 48 is de-energized and the moveable gripper 42 disengages from the drive rod 20.

As previously mentioned, a number of particular coil mechanisms and gripper mechanisms are possible. Whatever mechanical arrangement is employed for the grippers and lifting coils/armature arrangement, the coils have to operate effectively to produce a sufficient magnetic field so that the grippers can exert the designed force to prevent the control rod drive rods from dropping into the core which would necessitate an expensive shutdown of the reactor system. One or more large industrial fans are provided within or within the vicinity of the reactor head package to provide cooling air to protect the integrity of the control rod drive mechanism coil assemblies. The fan assemblies have to be disconnected and removed each time access to the core is required. The embodiments described herein obviate the need for and cost of these large industrial fans.

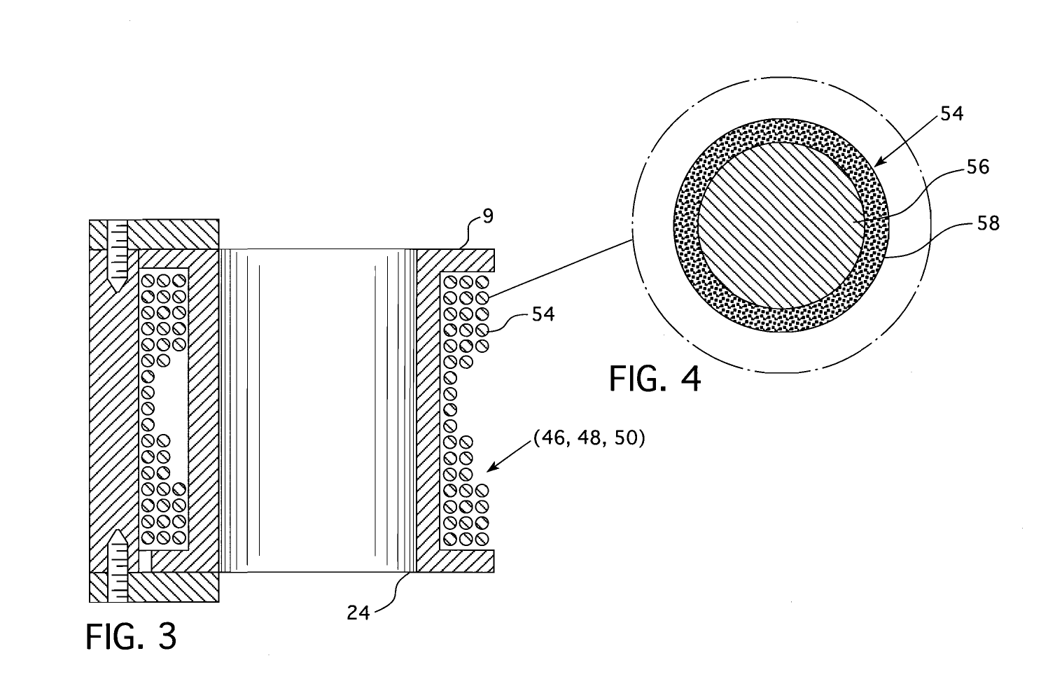

FIG. 3 shows a cross section of one embodiment of one of the coils 46, 48 or 50. The inventions claimed hereafter replace the existing CRDM coil assemblies with a more robust designed coil assembly that is thermally insensitive to the traditional reactor head area temperatures of approximately 570° F. (approximately 300° C.) while maintaining the same functionality. The source of the thermally limited life of the existing coil assemblies is the extensive use of organic materials of construction. These organic materials of construction are excluded using the concept claimed hereafter to eliminate thermal life replacement as a maintenance consideration as well as eliminate the need for cooling fans. FIG. 3 generally shows a cross section of one of the stationary gripper, moveable gripper or lift coils with an enlarged cross section of one of the coil wires shown in FIG. 4. The embodiments described herein preferably use a ceramic or quartz coating 58 as insulation around the wires 56 in place of the existing coils which utilize traditional rubber insulation in combination with an epoxy and RTV (Room Temperature Vulcanizating—a material that cures at room temperature) based potting. Though it should be appreciated that any high temperature insulation could be used that is capable of enduring the environment around the reactor vessel for extended periods without external cooling. The ceramic or quartz coating could either be preinstalled on the wire prior to winding the necessary number of coils or installed in powder, liquid or film form after the wire is formed in a coil. The insulation could also be constructed in the form of a flexible sleeve that can be drawn over the coil wire. For the sleeve form, the quartz or ceramic particles or fibers are combined with a consumable binder such as fiberglass to assist in forming strings to knit a woven sleeve. The insulation could also be in a solid form. In the latter case the dielectric, which can be a conventional quartz or ceramic dielectric material may be supplied as short rods, beads or discs with preformed holes for the coil wires to be pulled through. With the wires in place the solids may be crushed to form a granular powder. Silicon dioxide (SiO₂) is one example of a quartz material that may be used for the high temperature insulation. The ceramic families of acceptable insulation include Alumina Oxide (Al₂O₃) and Magnesium Oxide MgO). It should also be appreciated that the ceramic or quartz coating could be applied in combination with a corrosion resistant (e.g., stainless steel) thin wall tubing that could be drawn down either prior to or after the coiling operation. Furthermore, the conductor cross section could be modified to optimize the shape to allow for a uniform or equally spaced amount of dielectric between each wire in the coil. Employing this concept does away with periodic replacement due to any negative effect of the radiation environment in the reactor head area. The absence of organic materials of construction makes this concept impervious to the affect of the radiation environment.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear reactor having a plurality of control rods that are driven into and out of a nuclear core by a magnetic jack mechanism, the nuclear reactor comprising:
a drive rod connected to at least some of the control rods and moveably supported outside of the nuclear core along an axial drive path that aligns the control rods with which it is connected with guide thimbles in a fuel assembly within the nuclear core;
a housing extending from the nuclear reactor in the axial direction and enclosing at least a portion of the drive path;
a plurality of electric wire coils positioned around the housing for energizing the magnetic jack mechanism; and
a high temperature insulation positioned around and between the electric wire coils that is capable of withstanding, without substantial degradation, an operating temperature of the nuclear reactor without external cooling.

2. The nuclear reactor of claim 1 wherein the high temperature insulation is coated on the coils.

3. The nuclear reactor of claim 2 wherein the high temperature insulation is a liquid coating.

4. The nuclear reactor of claim 2 wherein the high temperature insulation is a powdered coating.

5. The nuclear reactor of claim 1 wherein the high temperature insulation is a quartz material.

6. The nuclear reactor of claim 5 wherein the quartz material comprises Silicon Dioxide.

7. The nuclear reactor of claim 1 wherein the high temperature insulation is a ceramic material.

8. The nuclear reactor of claim 7 wherein the ceramic material is selected from the group consisting of Alumina Oxide and Magnesium Oxide.

9. The nuclear reactor of claim 1 wherein the high temperature insulation is a flexible sleeve.
